(19) United States
(12) Patent Application Publication
(10) Pub. No.: US 2010/0163669 A1
(43) Pub. Date: Jul. 1, 2010

(54) Super aircraft structrue

(76) Inventor: Sunstar Im, Lancaster, CA (US)

Correspondence Address: SUNSTAR, IM, 22847 WEST AVENUE D. # 105, LANCASTER, CA, 93536, US

(21) Appl. No.: 12/317,733

(22) Filed: Dec. 29, 2008

(51) Int. Cl. B64C 1/00; B64C 3/00; B64D 11/00; B64C 35/00; B64D 11/06; B64C 9/00; B64C 3/14; B64C 1/14; B64C 25/04; B64D 45/00

(52) U.S. Cl. 244/36; 244/45 R; 244/119; 244/118.5; 244/106; 244/118.6; 244/87; 244/35 R; 244/129.5; 244/100 R; 244/129.2

(57) ABSTRACT

An aircraft structure is provided. The aircraft structure for an aircraft includes a fuselage, front wings, rear small wings, vertical winglets, and four levels. The fuselage has a cross-section of substantially a half circle fuselage shape. Being is wide enough to provide lifting force, and includes four levels separated by multi partition structure. The front wings are disposed horizontally in front portions of the fuselage. The rear small wings are disposed horizontally in rear portions of the fuselage. The vertical winglets are disposed at the wingtips of the rear small wings. The first level disposed at a bottom of the four levels includes a fuel tank storages and a plurality of landing gear bays. The second level disposed at a middle of the four levels includes cargo bay. The third level may comprise a top cockpit and a plurality of passenger cabins. The fuselage provides major portion of lifting force and the wings provides steering force, and lifting force. The fourth level may comprises a plurality of passenger cabins.

### BACKGROUND OF THE INVENTION

The present invention relates to a Super Aircraft structure. More particularly, this invention relates to an aircraft structure, which includes a half circle fuselage shape and wide body fuselage. A major research and development is an aerodynamic and structural efficiency to accomplish a mass capacity load. Integration of the laminar flow fuselage body and wings with leading edge sweep angel, in particularly aerodynamic and structural efficiency. Additionally, as the vehicle will have a light weight structure with high-as-pect-ratio fuselage body that carries much of the fuel mass, cargo mass, and passengers. Also multi landing gear bay system to reduce structure stress, and bending loads. Aircrafts have a half circle fuselage shape. The fluid dynamics in the atmosphere determines naturally laminar airflow of the aircraft. The fuselage is for carrying the load including passengers and freight. The loading capacity of the aircraft is reflected in the designing of the fuselage. The wings are where the aircraft gets the lifting force. The shape and size of the wings depend on the on the fluid dynamics and the fuselage. Therefore, large and strong wings have been considered natural and windely spread in almost all types of aircraft. The large wingspan and relatively a half circle fuselage shape in cross section has been with such kinds of fuselage.

Prior arts include US Patents;

| | | | | |
|---|---|---|---|---|
| 1,780,813 | 2,380,289 | 2,380,290 | 2,616,639 | 2,734,701 |
| 3,405,058 | 3,405,893 | 3,630,471 | 3,761,041 | 3,869,102 |
| 4,146,199 | 4,161,300 | 4,165,058 | 4,379,533 | 4,674,712 |
| 5,275,356 | 5,415,365 | 5,183,628 | 5,823,468 | 5,992,797 |
| 6,047,923 | 6,070,831 | 6,098,927 | 6,129,308 | 6,568,632 |
| 6666406B2 | 6,708,924 | 7,249,732 | 7,261,257 | |

To accomplish many objectives which were not possible, it is necessary to break the well-established ideas about the fuselage and the wigs. Accordingly, a need for an aircraft structure has been present for a long time. This invention is directed to solve these problems and satisfy the long-felt need.

### SUMMARY OF THE INVENTION

The present invention contrives to solve the disadvantages of the prior art. An objective of the invention is to provide an aircraft structure. Another objective of the invention is to provide an aircraft structure, which includes a substantially a half circle fuselage and wide body fuselage. Still another object of the invention is to provide an aircraft structure, which includes a fuselage having four levels. Still another objective of the invention is to provide an aircraft structure, which includes, multi fuel tank storage. Still another object of the invention is to provide an aircraft structure, which includes, a wing system of reduced thickness integrated with the First level of the fuselage. An aspect of the invention provides an aircraft structure. The aircraft structure for an aircraft comprises a fuselage, two large front wings, two rear small wings, two vertical winglets, a first level, a second level, a third level, and a fourth level. The fuselage has a cross section of substantially a half circle fuselage shape in a direction of width, and the fuselage is wide enough to provide lifting force, and comprises four levels which are separated by multipartition structure. The two front wings are disposed horizontally in front portions of the fuselage, and are configured to provide lifting force of the aircraft. The two small rear wings are disposed horizontally in rear portions of the fuselage, and are configured to control flight of the aircraft. The two vertical winglets are disposed at the wingtips of the corresponding rear small wings. The first level is disposed at the bottom of the four levels of the fuselage, and comprises a plurality of fuel tank storage. Each of the plurality of fuel tank storages comprises a plurality of partition compartments. The first level is configured to anchor the front wings and the rear small wings. The second level is disposed at the middle of the four levels to provide at the middle of the four levels of the fuselage, and comprises a cargo bay. The third level is disposed at the middle of the four levels of the fuselage, and comprises a top cockpit and a plurality of passenger cabins. The fuselage provides major portion of lifting force and the wings provide steering force, and lifting force. The fuselage may further comprise a bottom cockpit at a front portion of the belly of the fuselage. The bottom cockpit may be for controlling the aircraft during takes-off and landing, and may comprises one or more windows facing downward. The fourth level is disposed at the top of the fourth levels of the fuselage and comprises a passenger cabin. The fuselage may float in water. The third level may further comprise a plurality of seating systems and bedding systems. The third level may further comprise a plurality of doors along both sides of the fuselage. The fourth level and the third level may further comprise a plurality of multi-passenger windows along both sides of the wall unit of the passenger cabin compartment. The third level may further comprise a plurality of stair case system for easy access for walking through the upper stage and down stage. Between third level passenger cabin and fourth level passenger cabin. The aircraft structure may further comprise a spoiler at rear top portion of the fuselage. Each of the two front wings may comprise an elevator. Each of the two front wings may have a cross-sectional shape of lamina flow. Each of the two front wings and the two rear small wings may comprise a plurality of carbon fiber composite tubes with a plurality of punched holes, the tubes being interconnected at a plurality of assembling cutaways provided in the tubes and glued in a grid structure. The cargo bay in the second level may comprise a plurality of doors for loading and unloading. Some of the plurality of landing gear bays may be aligned in two parallel lines in the first level, and opened downwardly from under the belly portion of the fuselage. The first level may further comprise a plurality of hydraulic operating system and pneumatic system for controlling the landing gears. Each of the fuselage, walls, floors, and the roofs for the four levels may comprise a plurality of carbon fiber composite rectangular tubes interconnected at a plurality of assembling cutaways provided in the tubes and glued in a net grid structure. The tubes may further include still other holes for electric, pneumatic, and hydraulic lines or pipes. The tubes of these types are necessary in almost all the parts of the aircraft including wings. The net grid structure may comprise a plurality of fire retardant foam panels between the tubes. Alternatively, the net grid structure may comprise a plurality of fire retardant foam panels around the tubes. Still in other embodiments, the net grid structure may comprise a plurality of fire retardant foam panels between the tubes, and each of the plurality of fire retardant form panels may have a honey comb structure, with carbon fiber skin. The first level may further comprise one or more pumping station and valve control gauges. The first level may be integrated with the two front wings and the two rear small wings. Each of some of the two front wings and the two rear small wings may comprise one or more elevators. Each of the two vertical winglets may comprise a stabilizer. Another aspect of the invention provides an aircraft structure for an aircraft, comprising a fuselage having a cross-section of the substantially a half circle fuselage shape in a direction of width, the fuselage being wide enough to provide lifting force, wherein the fuselage comprises four levels, an upper surface, and a lower surface, wherein the four level are separated by multi-partition structure, and wherein the upper surface of the fuselage has an airfoil to provide lifting force. The advantages of the present invention are: (1) the aircraft structure can provide more lift with the flat fuselage; and (2) the aircraft structure enables four levels of structure for accommodating more space separated independently. Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein: FIG. 1 is a perspective view showing an aircraft having a structure according to an embodiment of the present invention;

FIG. 2 is a top plan view of the aircraft of FIG. 1;

FIG. 3 is a side plan view of the aircraft of FIG. 1;

FIG. 4 is a front plan view of the aircraft of FIG. 1;

FIG. 5 is a rear plan view of the aircraft of FIG. 1;

FIG. 6 is a perspective top view of an aircraft according to another embodiment of the invention;

FIG. 7 is a perspective bottom view of the aircraft of FIG. 6;

FIG. 8 is a cross-sectional top view of third level of aircraft FIG. 6;

FIG. 9 is a cross-sectional top view of fourth level of an aircraft FIG. 6;

FIG. 10 is a cross-sectional top view of first level and second level of an aircraft FIG. 6;

FIG. 11 is a cross-sectional side view of an aircraft according to still another embodiment of the invention;

FIG. 12 is a cross-sectional side view of an aircraft according to still another embodiment of the invention;

FIG. 13 is a cross-sectional top view of an aircraft according to still another embodiment of the invention;

FIG. 14 is a perspective top and partial cross-sectional view of an aircraft according to an embodiment of the invention;

FIG. 15 is a cross-sectional front view of the aircraft of FIG. 14;

FIG. 16 is a perspective partial cut-out view of a cabin cargo bay, fuel tank storage, and landing gear bay in an aircraft according to an embodiment of the invention; and

FIG. 17 is a perspective partial cross-sectional view of carbon fiber composite rectangular tube interconnected structure.

FIG. 18 is a perspective partial cross sectional view of a half circular shape of carbon fiber composite rectangular tube interconnected structure.

### DETAILED DESCRIPTION EMBODIMENTS OF THE INVENTION

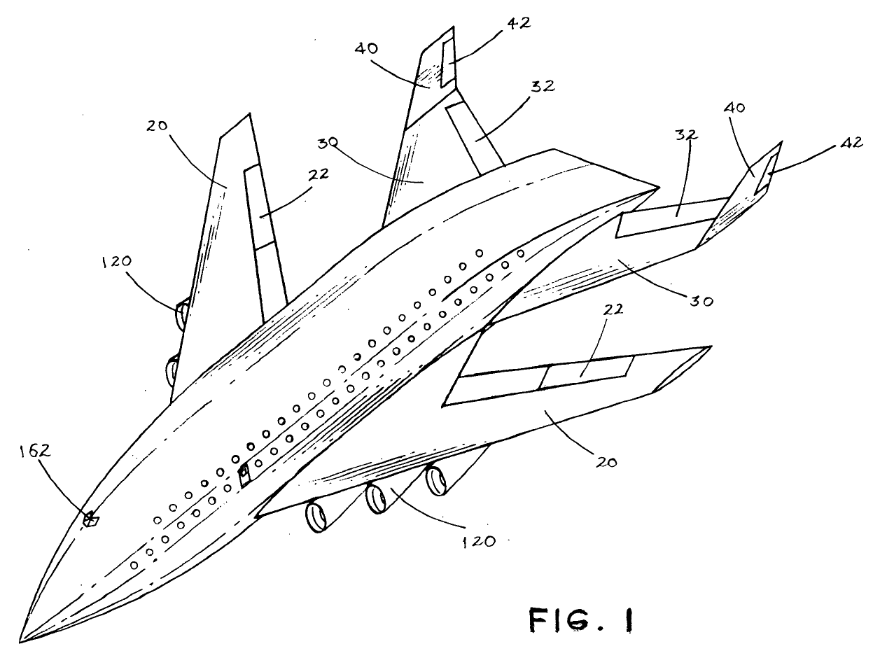

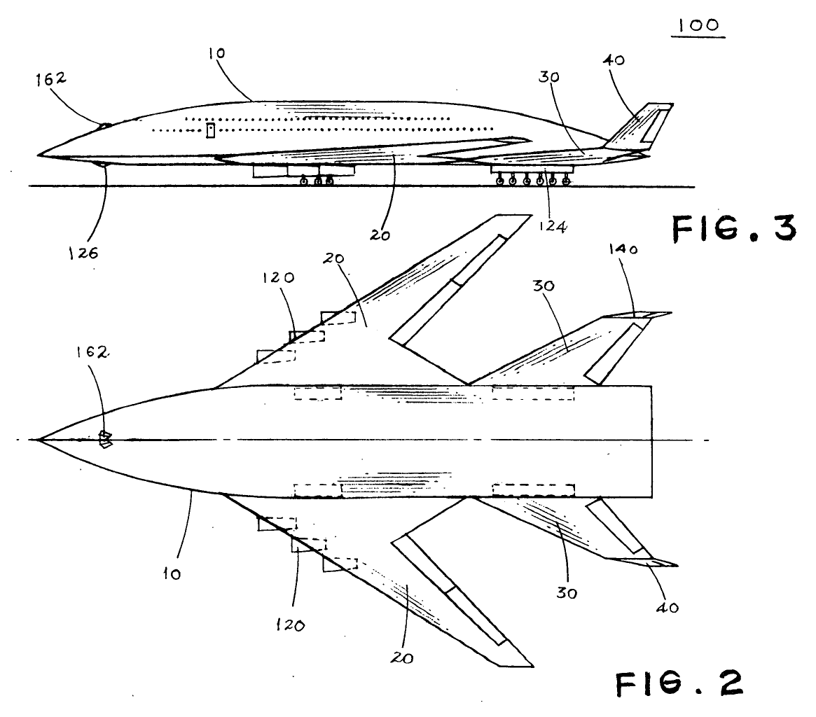

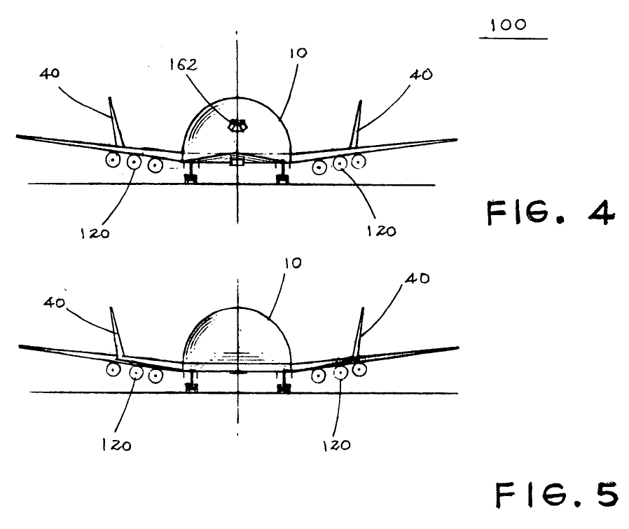

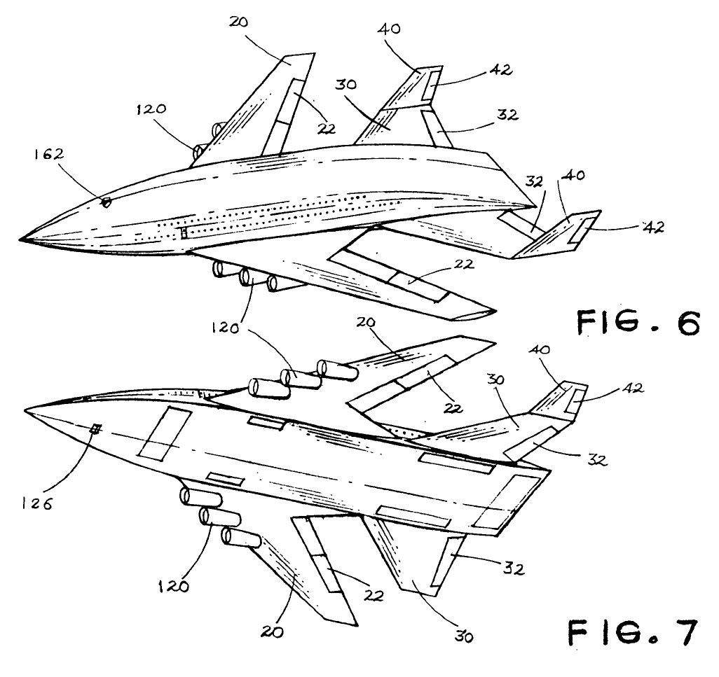

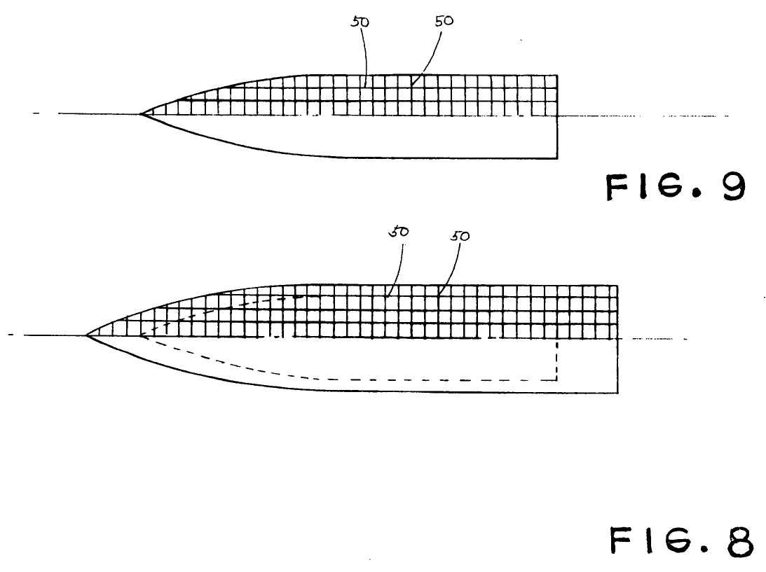

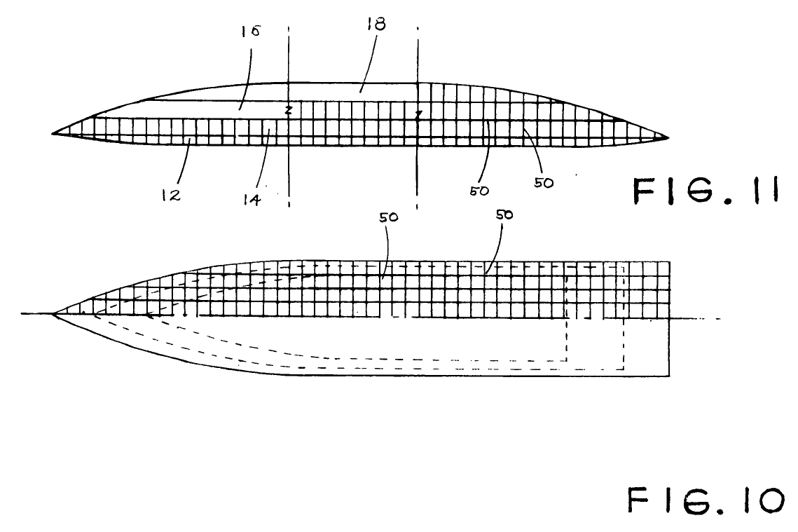

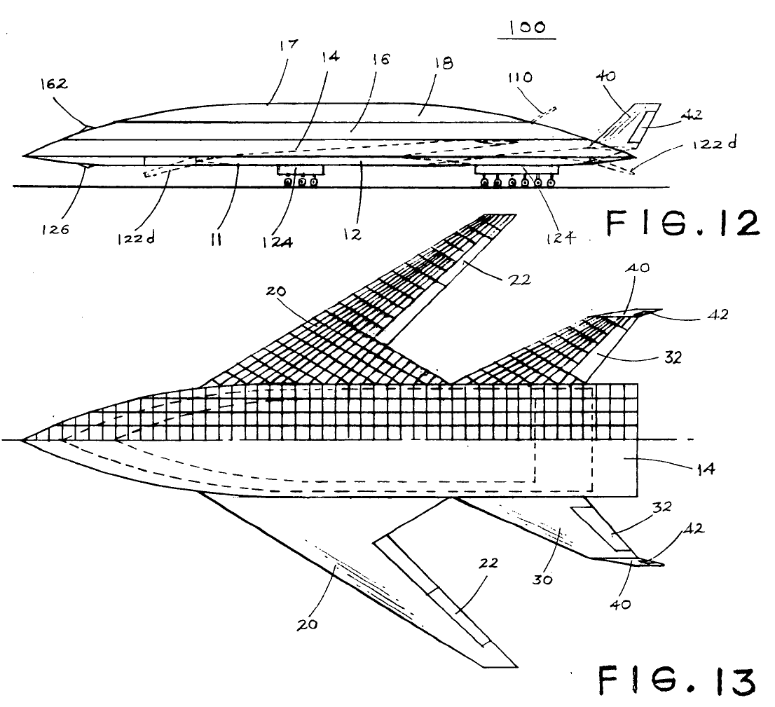

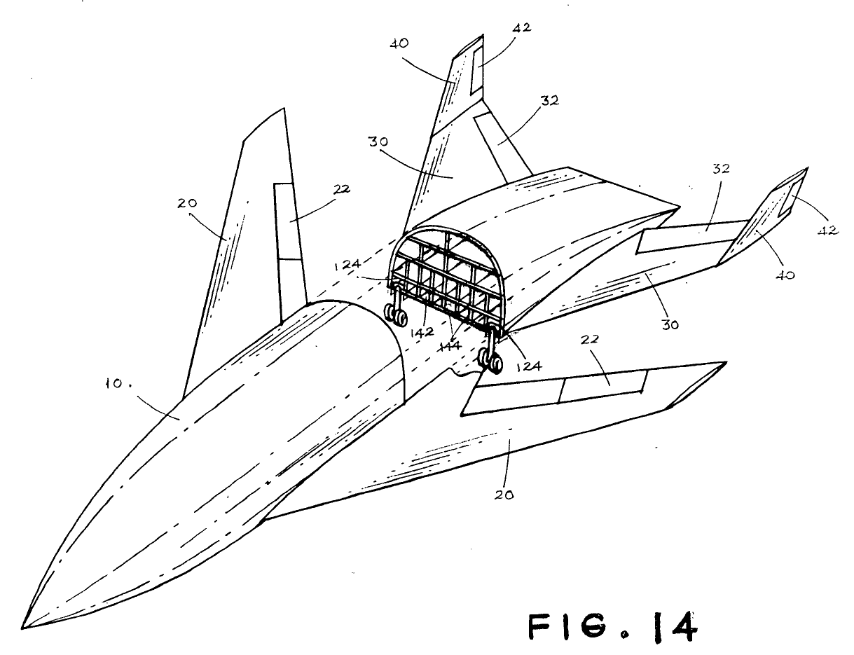

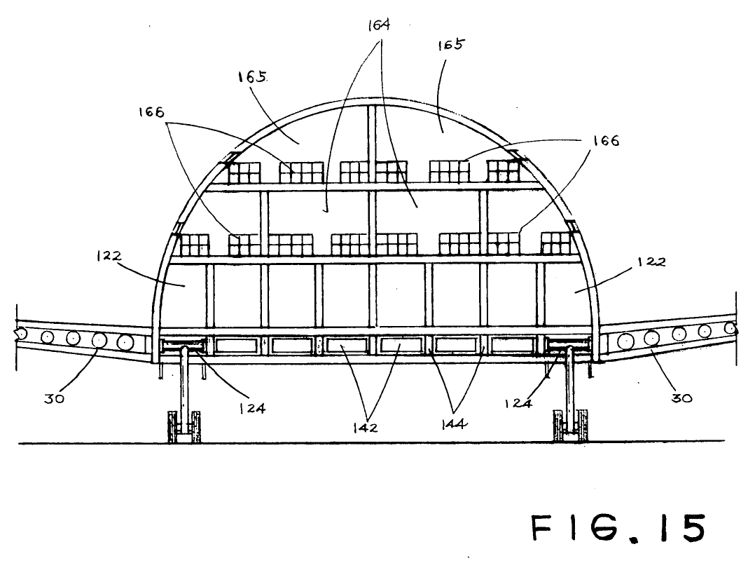

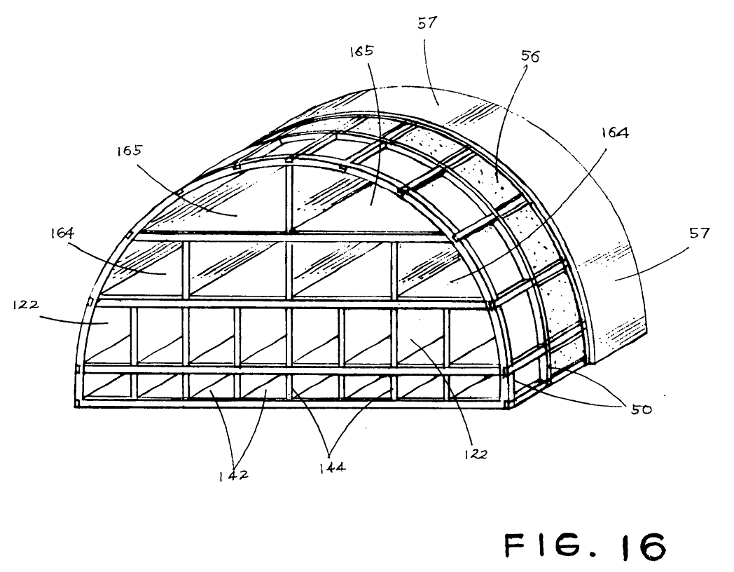

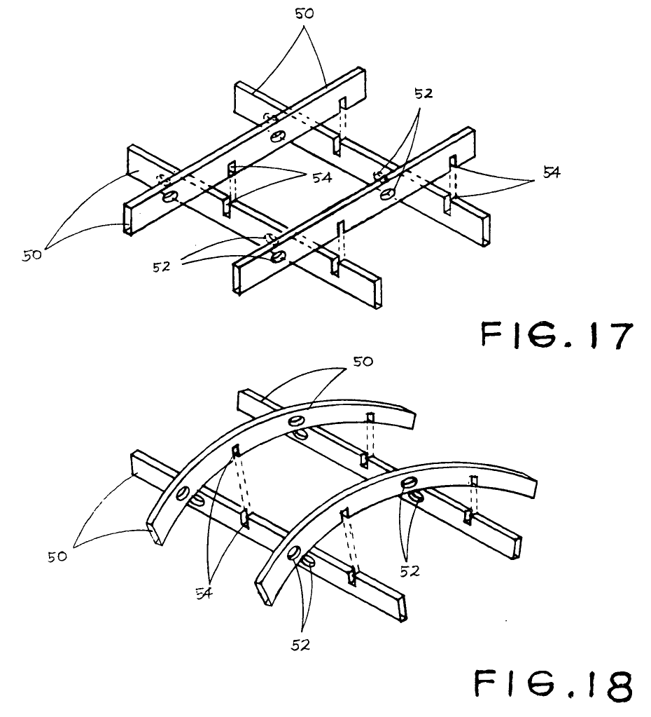

FIGS. 1-7 shows an aircraft 100 according to embodiments of the present invention. FIGS. 8-18 show inner structure of the aircraft 100. An aspect of the invention provides the illustrated structure of the aircraft 100. The aircraft structure for an aircraft 100 comprises a fuselage 10. The aircraft structure for an aircraft 100 may further comprise two front wings 20, two rear small wings 30, and two vertical winglets 40. The aircraft structure for an aircraft 100 may comprise a first level 12, a second level 14, a third level 16, and a fourth level 18. The fuselage 10 has a cross-section of substantially a half circle fuselage shape in a direction of width, and the fuselage 10 is wide enough to provide lifting force, and comprises four levels which are separated by multi-partition structure as shown in FIGS. 8,9,10,11, 12, and 13. The two front wings 20 are disposed horizontally in front portions of the fuselage 10, and are configured to control flight and lifting force of the aircraft 100. The two rear small wings 30 are disposed horizontally in rear portions of the fuselage 10, and are configured to control flight of the aircraft. The two vertical winglets 40 are disposed at wingtips of the corresponding rear small wings 30. The first level 12 is disposed at a bottom of the four levels of the fuselage 10, and comprises a plurality of fuel tank storage 142 each of the plurality of fuel tank storage a plurality of partition compartment 144 and a plurality of landing gear bays 124. The second level 14 is disposed at the middle of the four levels of the fuselage 10, and comprises a cargo bay 122. The first level 12 is configured to anchor the front wings 20 and the rear small wings 30. The third level 16 is disposed at a middle of the four levels of the fuselage 10, and comprises a cockpit 162 and a plurality of passenger cabins 164. The fourth level 18 is disposed at a top of the four levels of the fuselage 10 and comprises a plurality passengers cabin 165. The fuselage 10 provided major portion of lifting force and the wings 20, 30 provide lifting force and the wings 20, 30 provide steering force mainly. The wings 20, 30 also provide lifting force. The fuselage 10 may further comprise a bottom cockpit 126 at a front portion of a belly of the fuselage 10 as shown in FIG. 3,4,7,12. The bottom cockpit 126 may be for controlling the aircraft 100 during take-off and landing, and may comprise one or more windows facing downward. The fuselage 10 may float in water due to the structure tube with fire retardant foam sealed as shown in FIG. 16,56 with honeycomb carbon fiber skin panel 57 with glue as shown in FIG. 16. Since such a structure is water tight as well as air tight, the aircraft may be a sea plane used on a sea port. Third Level and the fourth level 16 may further comprise a plurality of seating systems and bedding system 166. The third level and the fourth level 16 may further comprise a plurality of doors along both sides of the fuselage 10. The aircraft structure may further comprise a spoiler 110 at a rear top portion of the fuselage 10 as shown in FIG. 12. Each of the two front wings 20 may comprise an elevator 22. Each of the two front wings 20 may have a cross-sectional shape of lamina flow as clearly seen in FIGS. 3, and 12. The air foil shape is provided with the wings 20, 30. However, since their size is right size lifting force by the wings is just right ratio compared to the lifting force of the fuselage 10. The ratio of the two lifting forces may be predetermined to optimize the flight. Each of the two front wings 20, and the two rear small wings 30 may comprise a plurality of carbon fiber composite rectangular tubes 50 with a plurality of punched holes 52, the tubes 50 being interconnected at a plurality of assembling cutaways 54 provided in the tubes 50 and glued in a grid structure as shown in FIGS. 8, 9, 10, 11, 13, 17, and 18. A cargo bay 122 in the second level 14 comprises a plurality of doors 122D for loading and unloading. Some of the plurality of landing gear bays 124 may be aligned in two parallel lines in the first level 12, and opened downwardly from under a belly portion of the fuselage 10 as shown in FIGS. 3, 4, 5, 12, 14, and 15. The first level 12 my further comprise a plurality of hydraulic operating system and pneumatic system for controlling the landing gears as shown in FIGS. 14, 15. Each of the fuselage 10, walls, floors, and roofs for the four levels 12, 14, 16, 18, may comprise a plurality of carbon fiber composite rectangular tubes 50 interconnected at a plurality of assembling cutaways 54 provided in the tubes 50 and glued in a net grid structure 50 as shown in FIGS. 16, 17, and 18. The net grid structure may comprise a plurality of fire retardant foam panels 56 between tubes 50 as shown in FIG. 16. Alternatively, the net grid structure may comprise a plurality of fire retardant foam panels 56 around the tubes 50. Still in other embodiments, the net grid structure may comprise a plurality of fire retardant foam panels 56 between the tubes 50, and each of the plurality of fire retardant foam panels 56 may have a honey comb structure 57. The first level 12 may further comprise one or more pumping stations and valves controlling gauges for fuel storage. The first level 12 may be intergraded with the two front wings 20 and the two rear small wings 30 as shown in FIGS. 13, 14. Each of some of the two front wings 20 and the two rear small wings 30 may comprise one or more elevators 22, 32. Each of the two vertical winglets 40 may comprise a stabilizer 42. Another aspect of the invention provides an aircraft structure for an aircraft 100, comprise a fuselage 10 having a cross-section of substantially a half circle fuselage shape in a direction of width, the fuselage 10 being wide enough to provide lifting force, wherein the fuselage 10 comprises four levels 12, 14, 16, 18 an upper surface 17 and a lower surface 11, wherein the four levels 12,

What is claimed is:

1. The aircraft structure of claim 1, comprising:
The fuselage having a cross-section substantially a half circle fuselage shape in a direction of width, The fuselage being wide enough to provide lifting force, wherein the fuselage comprises four levels, and wherein the four levels are separated by multi-partition structure, Wherein the fuselage provided major portion of lifting force and the wings provides lifting force and steering force.

2. The aircraft structure of claim 2,further comprising:
The Two front wings disposed horizontally in front portions of the fuselage, the two front big wings being configured to control fight of the aircraft, and provide lifting force the two rear small wings disposed horizontally in front portions of the fuselage, the two rear small wings being configured to control fight of the aircraft, and two vertical winglets, each of which being disposed at a wingtip of a corresponding one of the two rear small wings.

3. The aircraft structure of claim 3, further comprising:
A first level disposed at a bottom of the four levels of the fuselage, wherein the first level comprises a plurality of fuel tank storages, a plurality of partition compartments, and wherein the first level is configured to anchor the front wings and the rear small wings, and a second level disposed at a middle of four levels of the fuselage, wherein the second level comprises a cargo bay. A third level disposed at a middle of the four levels of the fuselage, wherein the third level comprises a top cockpit and a plurality of passenger cabins. a. Fourth level disposed at the four levels of the fuselage wherein the fourth level comprises a plurality of passenger cabins.

4. The aircraft structure of claims 4,wherein the fuselage further comprises a bottom cockpit at a front portion of a belly of the fuselage, wherein the bottom cockpit is for controlling the aircraft during take-off and landing comprises one or more window facing downward.

5. The aircraft structure of claim 5, wherein the fuselage floats in water.

6. The aircraft structure of claim 6, wherein the third level further comprises a plurality of seating systems and bedding systems, and wherein the third level further comprises a plurality of doors along both sides of the fuselage. The aircraft structure wherein the fourth level further comprises a plurality of seating system and bedding systems.

7. The aircraft structure of claim 7, further comprising of spoiler at rear top portion of the fuselage, wherein each of the two front wings comprises an elevator.

8. The aircraft structure of claim 8, wherein each of the two front wings has a cross-sectional shape of lamina flow.

9. The aircraft structure of claim 9, wherein each of the
two front wings and the two rear, small wings comprises a plurality of carbon fiber composite rectangular tubes with a plurality of punched holes, the tubes being interconnected at a plurality of assembling cutaways provided in the tubes and glued in a grid structure.

10. The aircraft structure of claim 10, wherein the cargo bay in the second level comprises a plurality of doors for loading and unloading, and wherein the plurality of doors are provided on front and rear portion of the bottom of the fuselage.

11. The aircraft structure of claim 11, wherein some of the
plurality of landing gear bays are aligned in two parallel lines in the first level, and opened downwardly from under a belly portion of the fuselage, and wherein the first level further comprises a plurality of hydraulic operating system and pneumatic system for controlling the landing gears.

12. The aircraft structure of claim 12, wherein each of the fuselage, walls, floors, and roofs for the four levels comprises a plurality of carbon fiber composite rectangular tubes interconnected at a plurality of assembling cutaways and punched holes provided in the net tubes and glued in a grid structure comprises a plurality of fire retardant foam panels between the tubes.

13. The aircraft structure of claim 13, wherein the net grid structure comprises a plurality of fire retardant foam panels around the tubes.

14. The aircraft structure of claim 14, where in the net grid structure comprises a plurality of fire retardant foam panels between the tubes, wherein each of the plurality of fire retardant form panels has a honey comb structure with carbon fiber skin.

15. The aircraft structure of claim 15, where in the first level further comprises one or more pumping station and valve controlling gauges.

16. The aircraft structure of claim 16, wherein the first level is integrated with the two front wings and two rear small wings.

17. The aircraft structures of claim 17, wherein each of some of the two front wings and the two rear small wings comprises one or more elevators, and wherein each of the two vertical winglets comprises a stabilizer.

18. The aircraft structure of claim 18, wherein the four levels comprise a building block system such that the disposition of the first, second, third, and fourth is interchangeable.

19. An aircraft structure for an aircraft, comprising:
A fuselage having a cross-section of substantially a half circle fuselage shape in a direction of width, the fuselage being wide enough to provide lifting force, wherein the fuselage comprises four levels, an upper surface, and a lower surface, and wherein the four levels are separated by multi-partition structure, Wherein the upper surface of the fuselage has an airfoil form to provide lifting force.
